(19) United States
(12) Patent Application Publication
(10) Pub. No.: US 2011/0051168 A1
(43) Pub. Date: Mar. 3, 2011

(54) IMAGE FORMING APPARATUS, MANAGING METHOD, AND COMPUTER-READABLE RECORDING MEDIUM HAVING RECORDED THEREIN PROGRAM FOR MANAGING METHOD

(75) Inventor: Kyoichi Shibata, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/869,041

(22) Filed: Aug. 26, 2010

Related U.S. Application Data
(60) Provisional application No. 61/239,578, filed on Sep. 3, 2009.

(51) Int. Cl. G06F 3/12

(52) U.S. Cl. 358/1.13

(57) ABSTRACT

An image forming apparatus includes: a designation-information acquiring unit configured to acquire processing condition designation information for designating processing conditions for image formation processing; a first weight-value acquiring unit configured to acquire a first weight value used for weighting in charging processing for the image formation processing, the first weight value corresponding to the processing condition designation information acquired by the designation-information acquiring unit; a charging-value calculating unit configured to calculate, using the first weight value acquired by the first weight-value acquiring unit, a charging unit value used for calculation of a charging amount for the image formation processing; a second weight-value acquiring unit configured to acquire, in limiting processing for limiting the image formation processing to a predetermined processing amount set in advance, a second weight value used for calculation of a subtraction value subtracted from the predetermined processing amount and corresponding to a processing amount of image formation processing to be executed, the second weight value corresponding to the processing condition designation information acquired by the designation-information acquiring unit; a subtraction-value calculating unit configured to calculate the subtraction value on the basis of the second weight value acquired by the second weight-value acquiring unit; and a first determining unit configured to determine whether a total of the subtraction value exceeds the predetermined processing amount.

### CROSS-REFERENCE TO RELATED APPLICATION

This application is based upon and claims the benefit of priority from U.S. provisional application 61/239,578, filed on Sep. 3, 2009; the entire contents of which are incorporated herein by reference.

### FIELD

Embodiments described herein relate generally to a charging technique corresponding to a degree of use of an image forming apparatus or a technique for limiting use of the image forming apparatus on the basis of the degree of use of the image forming apparatus.

### BACKGROUND

In the past, an image forming apparatus such as a copying machine, a printer, or an MFP (Multi Function Peripheral) includes a counter for counting the number of copies, the number of prints, or the like to charge a lease fee or a maintenance fee. The counter for charging can also perform counting weighted according to a processing condition designated when copying or printing is performed. For example, the counter performs weighting set in advance, for example, set to onefold for monochrome printing and set to twofold for color printing with respect to a reference value (amount) per one print and counts the number of prints.

An image forming apparatus such as an MFP shared by plural users has a quota function for limiting an amount of image formation processing usable by the users of the MFP making use of a counter for counting the number of prints for charging. An administrator of the MFP or the like can set, with the quota function, for example, upper limits of the number of prints as an amount of image formation processing that the respective users can use in one month. This makes it possible to limit a printing amount by the MFP and suppress costs of sheets, toners, and the like. When the weighting is set in counting, an amount of image formation processing is determined by using, as a quota, the same value to which the weighting is applied. Specifically, when the twofold weight is set for the color printing, the color printing has a printing amount twice as large as monochrome printing. Then, the users select the monochrome printing as much as possible to prevent the numbers of prints from reaching the upper limits of usable numbers of prints. This makes it possible to suppress use of sheets and toners.

However, with the quota in the past, it is not always possible to appropriately urge the users to save consumables and reduce the numbers of prints in the image formation processing.

### BRIEF DESCRIPTION OF THE DRAWINGS

FIG. 1 is a diagram of the configuration of an MFP as an image forming apparatus according to a first embodiment;

FIG. 2 is a functional block diagram for explaining functions of the MFP according to the first embodiment;

FIG. 3 is a weighting table for charging, which is a data table of weight values corresponding to processing conditions, used in calculating a charging value;

FIG. 4 is a weighting table for quota, which is a data table of weight values corresponding to processing conditions, used in calculating a quota value;

FIG. 5 is a flowchart for explaining a flow of charging processing and quota processing executed by the MFP;

FIG. 6 is a functional block diagram for explaining functions of an MFP according to a second embodiment;

FIG. 7 is a setting screen displayed by a setting-screen-display control unit;

FIG. 8 is a functional block diagram for explaining functions of an MFP according to a third embodiment;

FIG. 9 is a functional block diagram for explaining functions of an MFP according to a fourth embodiment;

FIG. 10 is a functional block diagram for explaining functions of an MFP according to a fifth embodiment;

FIG. 11 is a functional block diagram for explaining functions of an MFP according to a sixth embodiment;

FIG. 12 is a functional block diagram for explaining functions of an MFP according to a seventh embodiment; and

FIG. 13 is a functional block diagram for explaining functions of an MFP according to an eighth embodiment.

### DETAILED DESCRIPTION

In general, according to an embodiment, an image forming apparatus includes a designation-information acquiring unit, a first weight-value acquiring unit, a charging-value calculating unit, a second weight-value acquiring unit, a subtraction-value calculating unit, and a first determining unit. The designation-information acquiring unit acquires processing condition designation information for designating processing conditions for image formation processing. The first weight-value acquiring unit acquires a first weight value used for weighting in charging processing for the image formation processing, the first weight value corresponding to the processing condition designation information acquired by the designation-information acquiring unit. The charging-value calculating unit calculates, using the first weight value acquired by the first weight-value acquiring unit, a charging unit value used for calculation of a charging amount for the image formation processing. The second weight-value acquiring unit acquires, in limiting processing for limiting the image formation processing to a predetermined processing amount set in advance, a second weight value used for calculation of a subtraction value subtracted from the predetermined processing amount and corresponding to a processing amount of image formation processing to be executed, the second weight value corresponding to the processing condition designation information acquired by the designation-information acquiring unit. The subtraction-value calculating unit calculates the subtraction value on the basis of the second weight value acquired by the second weight-value acquiring unit. The first determining unit determines whether a total of the subtraction value exceeds the predetermined processing amount.

Embodiments are explained below with reference to the accompanying drawings.

### First Embodiment

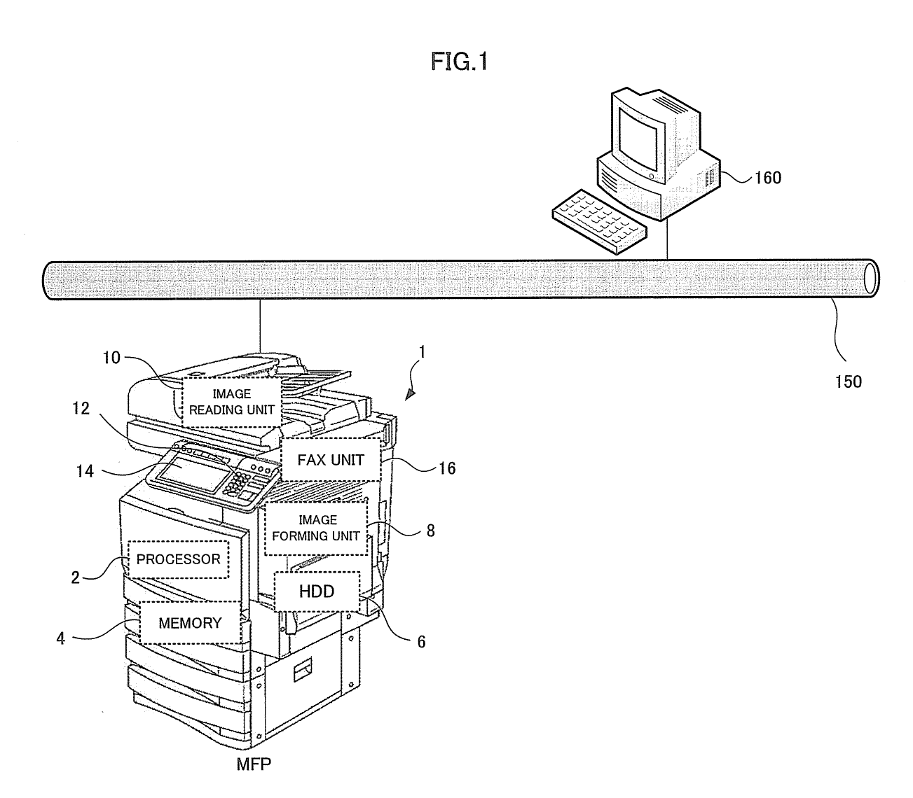

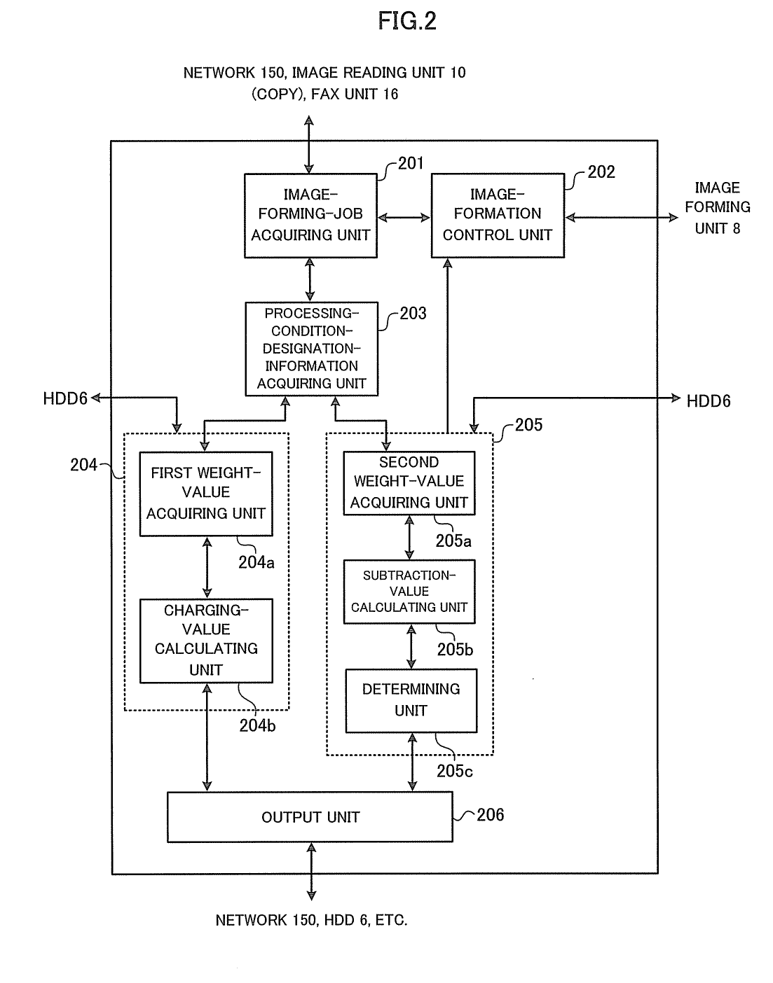

FIG. 1 is a diagram of the configuration of an MFP (Multi Function Peripheral) 1 as an image forming apparatus. FIG. 2 is a functional block diagram for explaining functions of the MFP 1.

The MFP 1 includes a processor 2, a memory 4, an HDD 6, an image forming unit 8, an image reading unit 10, an operation input unit 12, a display unit 14, and a facsimile unit 16. As shown in FIG. 1, the MFP 1 is connected to a terminal 160 via a network 150. For example, when a print job is output from the terminal 160, the MFP 1 acquires the print job via the network 150. The image forming unit 8 performs image formation processing on the basis of the print job. In this embodiment, the image formation processing indicates processing for forming an image on a sheet. Specifically, the image formation processing is, for example, printing based on a print job output via a network or the like, printing based on a copy job, or printing performed when a facsimile is received.

The components of the MFP 1 are explained below. The processor 2 is a processing device configured to control various kinds of processing in the image forming unit 8, the image reading unit 10, and the like. The processor 2 executes computer programs stored in the memory 4 and the HDD 6 to thereby realize various functions and execute the processing. As the processor 2, a CPU (Central Processing Unit), an MPU (Micro Processing Unit) that can execute arithmetic processing equivalent to that of the CPU, or the like is used. An ASIC (Application Specific Integrated Circuit) as a processor may realize a part or all of the functions of the MFP 1.

Further, the processor 2 according to this embodiment realizes functions such as a charging function for reading a computer program stored in a storage device such as the memory 4 or the HDD 6 and performing charging according to the image formation processing in copying or printing and a quota function for calculating a numerical value concerning an image formation processing amount, performing processing for subtracting the numerical value from a predetermined amount (hereinafter also referred to as quota value) for permitting the image formation processing set in advance, and limiting use of the MFP 1 to processing equivalent to the quota value.

The memory 4 stores a computer program for the processor 2 to execute the image formation processing in the image forming unit 8, image reading processing in the image reading unit 10, and the like. In the image formation processing, the memory 4 is used for temporarily storing image data generated by RIP processing and is used as a work area for various applications. Further, the memory 4 temporarily stores a signal of an image forming job or the like acquired via the network 150, an operation input signal from the operation input unit 12, and the like.

In this embodiment, the memory 4 stores computer programs for realizing the charging function and the quota function. When a part of the processor 2 or the entire processor 2 is an ASIC, it is unnecessary to store the computer programs for realizing the charging function and the quota function.

As the memory 4, for example, a RAM (Random Access Memory), a ROM (Read Only Memory), a DRAM (Dynamic Random Access Memory), an SRAM (Static Random Access Memory), a VRAM (Video RAM), or a flash memory is used.

The HDD 6 is an auxiliary storage device configured to store various kinds of information in the MFP 1. The auxiliary storage device for the MFP 1 is not limited to a hard disk drive. For example, a flash memory, an SSD (Solid State Drive), or a magnetic disk other than an HDD may be used.

The HDD 6 in this embodiment stores a quota value set in advance. When the image formation processing is performed, a subtraction value equivalent to the processing is subtracted from the quota value stored in the HDD 6. A quota value after the subtraction is overwritten and stored. When a charging value (a charging unit value) as a unit of charging calculated in the MFP 1 is stored in the MFP 1, the HDD 6 stores the charging value.

When the image forming unit 8 receives an instruction for copying, printing, facsimile, or the like, the image forming unit 8 forms an acquired image on a sheet. The image forming unit 8 includes, for example, a fixing device and a photoconductive member.

The image reading unit 10 is a general image reading device included in a copying machine, an image scanner, or the like. The image reading unit 10 performs reading of an original document.

The operation input unit 12 is a device configured to perform operation in using the various functions of the MFP 1. The operation input unit 12 includes, for example, a keyboard, a touch panel, or buttons for exclusive use.

The display unit 14 is a device configured to display an operation state or the like of the MFP 1. The display unit 14 includes, for example, an LCD (Liquid Crystal Display), an EL (Electro Luminescence), or a PDP (Plasma Display Panel)

The facsimile unit 16 transmits and receives image data via a telephone line.

The configuration of the MFP 1 according to this embodiment is as explained above.

The network 150 configured to connect the MFP 1 and the terminal 160 or the like can include, for example, the Internet, a LAN (Local Area Network), or a WAN (Wide Area Network).

The “charging function” in this embodiment is explained. The charging function in this embodiment is a function for, for example, a leasing company of the MFP 1 to charge a lease fee for each predetermined image formation processing unit (e.g., printed pages (number of sheets)). As calculation of a charging amount, weighting corresponding to processing conditions designated in printing is performed to calculate a charging value for calculating the charging amount and the charging amount is calculated on the basis of the charging value.

Specifically, for example, a reference value of printing for one sheet is set as one point, the reference value is multiplied with a weight value (1, 2, 0.8, etc.) corresponding to processing conditions such as a sheet size, a type of a sheet, and designation of color printing or monochrome printing to calculate a charging value for every one sheet to be printed. For example, a charging value for printing of one sheet when the sheet size is A4, the sheet type is thick paper, and the color printing is set is calculated as, when the reference value is 1, a weight value in the case of A4 is 1, a weight value in designation of thick paper is 2, and a weight value for the color printing is 2, 1×1×2×2=4 points. When a charging amount is calculated, the charging amount can be calculated by, for example, multiplying a total of calculated charging values with a charging amount per one point. If the charging amount is 1 yen for one point, a charging amount in the example of printing explained above is 4×1=2 yen.

The “quota function” in this embodiment is explained. The quota function is, as explained above, a function for limiting an image formation processing amount (a printing amount) with which a user can perform image formation. Basically, regulation processing for, for example, setting an allocated number of sheets (a quota value) for permitting printing in a predetermined period (e.g., one month), subtracting the number of sheets printed in every printing (a subtraction value) from the allocated number of sheets, and, when the number of allocated sheets is 0, stopping further use is performed.

In the case of an actual quota function in this embodiment, processing for setting a quota value as a predetermined processing amount for permitting a user to perform printing and, every time printing is performed, subtracting, from the quota value, a subtraction value calculated by applying weight corresponding to conditions set in the printing is performed. Specifically, a reference value for printing one sheet is set as one point, the reference value is multiplied with a weight value (1, 2, 0.8, etc.) corresponding to designated contents or the like such as a sheet size, a type of a sheet, designation of color printing or monochrome printing, and setting for printing plural pages on one sheet (N in 1 setting) to calculate a subtraction value for every one sheet to be printed. For example, a subtraction value in printing of one sheet when the sheet size is A4, the sheet type is thick paper, monochrome printing is set, layout printing for printing data for two pages on one sheet (2 in 1 printing) is set is calculated as, when the reference value is 1, a weight value in the case of A4 is 1, a weight value in designation of thick paper is 2, a weight value for the monochrome printing is 1, and a weight value for the 2 in 1 printing is 0.8, 1×1×2×1×0.8=1.6. Therefore, for example, if a quota value immediately before the printing is 100, a quota value after the printing is 100−1.6=98.4. In this case, if a quota value after the subtraction is equal to or larger than 0, the printing is permitted. However, a quota value after the subtraction is smaller than 0, the quota amount is insufficient and a printing amount exceeds the allocated quota value. Therefore, the printing is stopped.

The charging function and the quota function are realized by functional blocks explained below realized when the processor 2 reads the computer programs stored in the memory 4 or the like.

Functional blocks of the MFP 1 according to this embodiment are explained below with reference to FIG. 2. FIG. 2 is a functional block diagram for explaining functions of the MFP 1 according to this embodiment. The MFP 1 according to this embodiment includes an image-forming-job acquiring unit 201, an image-formation control unit 202, a processing-condition-designation-information acquiring unit 203, a charging unit 204, a quota unit 205, and an output unit 206. The charging unit 204 includes a first weight-value acquiring unit 204a and a charging-value calculating unit 204b. The quota unit 205 includes a second weight-value acquiring unit 205a, a subtraction-value calculating unit 205b as an image-forming-amount calculating unit, and a determining unit 205c as a first determining unit. The functional blocks are explained below.

The image-forming-job acquiring unit 201 acquires a print job output from the terminal 160 or the like connected via the network 150, acquires, together with a print instruction, an image read in copy processing, and acquires, together with the print instruction, an image received from the facsimile unit 16.

The image-formation control unit 202 performs, on the basis of an image forming job acquired by the image-forming-job acquiring unit 201, processing for causing the image forming unit 8 to form an image on a sheet. However, the image-formation control unit 202 in this embodiment can stop execution of the acquired image forming job when a quota value set by the quota unit 205 explained later is smaller than 0.

The processing-condition-designation-information acquiring unit 203 acquires various processing conditions designated for image formation processing included in the image forming job. Specifically, the processing conditions are conditions at the time of image formation such as a sheet size, a type of a sheet, the number of pages per one sheet (setting of layout printing or N in 1 printing), simplex or duplex printing, and color or monochrome printing. The processing-condition-designation-information acquiring unit 203 acquires, from the image forming job, information for designating these various processing conditions.

The charging unit 204 calculates a charging value for calculating a charging amount. Specifically, the first weight-value acquiring unit 204a of the charging unit 204 extracts, referring to a weighting table for charging stored in the HDD 6, weight values corresponding to processing conditions designated in image formation processing about to be executed.

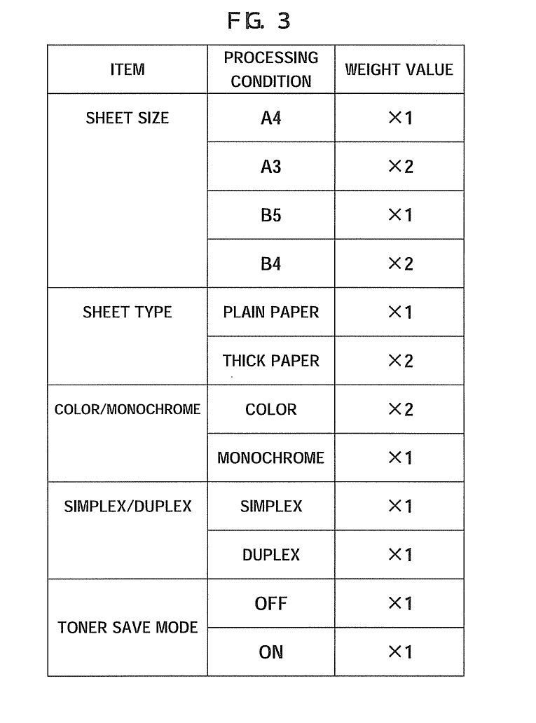

A weighting table for charging 300 as a data table of weight values corresponding to processing conditions used in calculating a charging value is shown in FIG. 3. In the weighting table for charging 300, items of the processing conditions, processing conditions that can be designated for the items, and weight values multiplied with a reference value when the conditions are designated are registered in association with one another. For example, in the weighting table for charging 300 shown in the figure, when a processing condition for a sheet size item is A4, a weight value is 1.

The charging-value calculating unit 204b of the charging unit 204 multiplies a reference value (e.g., “1”) with a weight value corresponding to a designated processing condition and extracted by the first weight-value acquiring unit 204a to calculate a charging value for the image formation processing about to be executed.

The quota unit 205 calculates a quota value for limiting the image forming processing with a predetermined processing amount and, when the quota value is smaller than 0, performs processing for stopping the image formation processing. Specifically, the second weight-value acquiring unit 205a of the quota unit 205 extracts, referring to a weighting table for the quota function stored in the HDD 6, weight values corresponding to processing conditions designated in the image formation processing about to be executed.

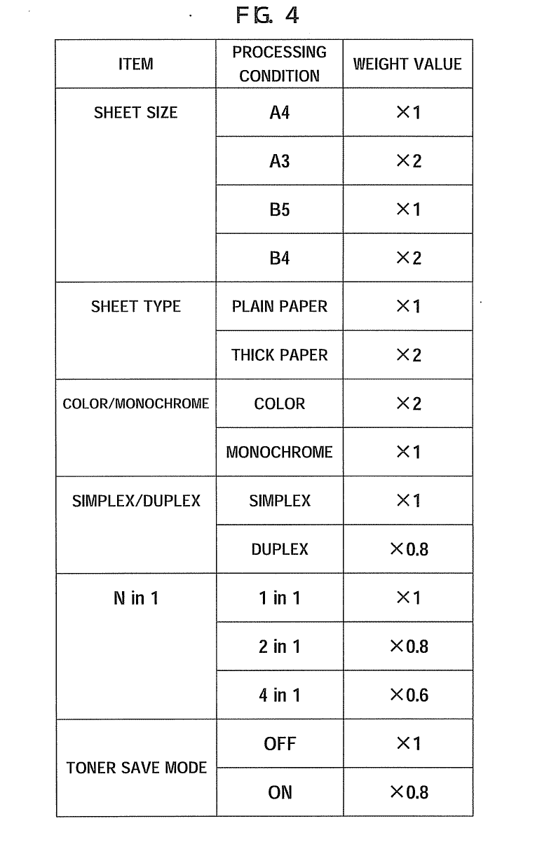

A weighting table for quota 400 as a data table of weight values corresponding to the processing conditions used in calculating a quota value is shown in FIG. 4. In the weighting table for quota 400, items of the processing conditions, processing conditions that can be designated for the items, and weight values multiplied with the reference value when the conditions are designated are registered in association with one another.

The items, the processing conditions in the items, and the weight values corresponding to the processing conditions registered in the weighting table for quota 400 can be set to contents different from those of the weighting table for charging. For example, a weight value of a condition for laying out plural pages to one sheet and printing the pages can be set smaller than 1. For example, in the weighting table for quota 400 shown in the figure, in the case of setting for laying out two pages to one sheet and printing the two pages (2 in 1 printing), a weight value is 0.8. In this case, since a subtraction value is small if the layout printing is designated, it is possible to urge a user to suppress the number of printed sheets.

In the weighting table for quota 400, as items or processing conditions not included in the weighting table for charging 300, an item of setting of the layout printing is conceivable. For example, the setting of the layout printing has an advantage that, although, in the case of charging, it is unnecessary to take into account how large the number of pages per one sheet is, for the administrator who desires to suppress use, the number of sheets to be consumed is smaller if plural pages are laid out and printed. Therefore, in the weighting table for quota 400, an item not included in the weighting table for charging 300 is set and, for example, weighting is set to be light. This makes it possible to effectively suppress the use of the MFP.

The subtraction-value calculating unit 205b of the quota unit 205 multiplies the reference value with the weight value extracted by the second weight-value acquiring unit 205a to calculate a subtraction value that is equivalent to a processing amount of the image formation processing about to be executed and is subtracted from the allocated quota value.

The determining unit 205c of the quota unit 205 acquires the quota value immediately before the image formation processing stored in the HDD 6 and subtracts the subtraction value calculated by the subtraction-value calculating unit 205b from the acquired quota value. The determining unit 205c determines whether a quota value after the subtraction is “equal to or larger than 0” or “smaller than 0”. If the quota value is equal to or larger than 0, the image formation processing is image formation processing within a range of the allocated quota value. Therefore, the determining unit 205c causes the image-formation control unit 202 to directly execute the image formation processing. On the other hand, if the quota value is smaller than 0, the image formation processing is image formation processing exceeding the allocated quota value, the determining unit 205c does not permit the image formation processing. In other words, in this case, the determining unit 205c causes the image-formation control unit 202 to stop the image formation processing.

The output unit 206 outputs the charging value calculated by the charging unit 204 and the quota value after the subtraction calculated by the quota unit 205 to storage areas, in which the charging value and the quota value are respectively stored, and stores the charging value and the quota value as a charging value for the image formation processing and a quota value after the image formation processing. The charging value calculated by the charging unit 204 can be output to an external server, which manages charging information, connected via the network 150, the HDD 6 of the MFP 1, or the like and store therein. Concerning the quota value after the subtraction of the subtraction value calculated by the quota unit 205, the quota value before the print processing stored in the HDD 6 is overwritten with the quota value after the processing and the quota value after the processing is stored. Not only the quota value but also the subtraction value for the image formation processing may be output to the HDD 6 or the like and stored therein. In that case, processing for outputting processing conditions designated in the image formation processing and weight values respectively corresponding to the processing conditions together with the subtraction value and storing the processing conditions and weight values may be performed. The quota value may also be output to the external server or the like connected via the network 150 and stored therein.

The configuration of the MFP 1 according to this embodiment and the functional blocks realized in the MFP 1 are as explained above.

With the MFP 1 according to this embodiment, the charging function and the quota function can perform, referring to the different weighting tables respectively corresponding thereto, calculation of a charging value for charging and calculation of a subtraction value and a quota value. Therefore, it is possible to realize optimum charging processing and quota processing (processing for limiting an amount of use) to which weightings matching respective purposes of charging and quota is applied. On the other hand, when a charging value and a subtraction value used for the quota function are calculated with the same weighting as in the past, since purposes such as charging and saving are different, it is impossible to sufficiently urge, with the quota function, the user to suppress the image formation processing.

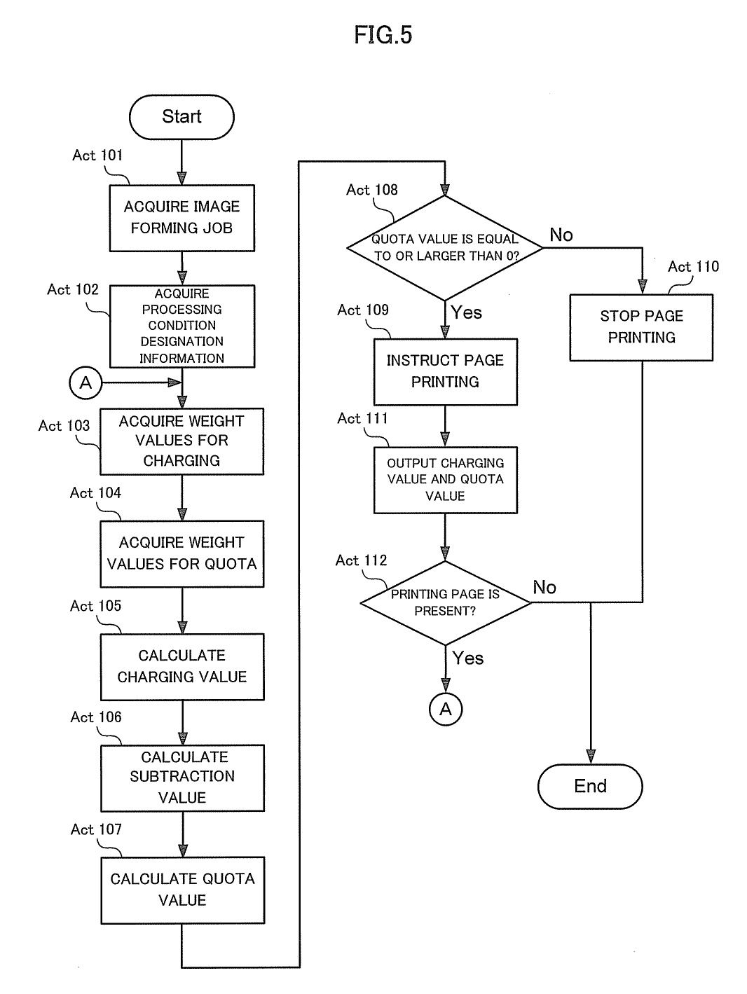

A flow of charging processing and processing by the quota function executed in the image formation processing by the MFP 1 is explained below. FIG. 5 is a flowchart for explaining a flow of the charging processing and the quota processing executed by the MFP 1.

First, in Act 101, the image-forming-job acquiring unit 201 acquires an image forming job. The image forming job is generated on the basis of a printing instruction or a copying instruction from a personal computer or the like, a printing instruction of a received facsimile, or the like.

Subsequently, in Act 102, the processing-condition-designation-information acquiring unit 203 acquires, concerning a page about to be printed, processing condition designation information of print processing designated in the acquired image forming job.

In Act 103, the first weight-value acquiring unit 204a of the charging unit 204 extracts, from the weighting table for charging 300 stored in the HDD 6, weight values for charging corresponding to processing conditions acquired in Act 102 and acquires the weight values.

In Act 104, the second weight-value acquiring unit 205a of the quota unit 205 extracts, from the weighting table for quota 400 stored in the HDD 6, weight values for quota corresponding to the processing conditions and acquires the weight values.

In Act 105, the charging-value calculating unit 204b of the charging unit 204 calculates, using the weight values for charging acquired in Act 103, a charging value of the page about to be printed. The charging value can be calculated by, for example, as explained above, multiplying a reference value with a weight value for charging corresponding to a designated processing condition.

In Act 106, the subtraction-value calculating unit 205b of the quota unit 205 calculates, using the weight values acquired in Act 104, a subtraction value that is a print processing amount for the page about to be printed. The subtraction value can be calculated by, in the same manner as the calculation of the charging value, multiplying the reference value with a weight value for quota corresponding to the designated processing condition.

In Act 107, the determining unit 205c of the quota unit 205 acquires a quota value immediately before the print processing is performed stored in the HDD 6, subtracts the subtraction value calculated in Act 106 from the acquired quota value, and calculates a quota value in printing of the page about to be printed.

In Act 108, the determining unit 205c determines whether a quota value after the subtraction is equal to or larger than 0 or smaller than 0. If the quota value is equal to or larger than 0. (Yes in Act 108), in Act 109, since the printing of the page is processing within the range of the allocated quota value, the determining unit 205c permits the printing and causes the image-formation control unit 202 to execute print processing for the page.

On the other hand, if the quota value is smaller than 0 (No in Act 108), in Act 110, since the printing of the page is printing exceeding the allocated quota value, the determining unit 205c does not permit the printing and causes the image-formation control unit 202 to stop print processing of the page. The determining unit 205c cancels the image forming job without performing the image formation processing for the remaining pages of the image forming job. In this case, the determining unit 205c may cause the display unit 14 of the MFP 1 to display indication that printing cannot be performed because the quota value is insufficient. When the image forming job is an image forming job from the terminal 160, the determining unit 205c may cause the terminal 160 to display the indication on a screen of the terminal 160.

In Act 111, the output unit 206 outputs the charging value calculated in Act 105 and the quota value calculated in Act 106 to storage areas respectively corresponding thereto and stores the charging value and the quota value in the storage areas. When a charging amount is calculated, it is possible to add up output charging values in the MFP 1, store a charging value as a total of the charging values in a predetermined storage area, and calculate a charging amount from the total charging value. As the storage areas for storing the charging value and the quota value, the HDD 6, a computer such as an external server connected via the network 150, or the like can be used.

In Act 112, the determining unit 205c determines whether all pages included in the acquired image forming job are printed, i.e., whether a page to be printed is still left concerning the image processing job being processed. If a page to be printed is still left (Yes in Act 112), the MFP 1 returns to Act 102, acquires processing condition designation information of a page to be printed next, and repeats the same processing. On the other hand, if the printing of all the pages included in the image forming job ends (No in Act 112), the MFP 1 ends the image formation processing.

The flow of the charging processing and the processing by the quota function executed in the image formation processing by the MFP 1 is as explained above.

In the flowchart shown in FIG. 5, the charging processing and the processing by the quota function are alternately executed in order. However, the order of the processing is not limited to the order shown in FIG. 5. For example, after one of the kinds of calculation processing for a charging value and a quota value is completely ends, the other of the kinds of calculation processing may be executed. Both the kinds of processing may be executed in parallel. When the print processing is stopped by the quota function, printing of a page to be printed is not executed and it is unnecessary to perform charging. Therefore, a charging value may be calculated only when execution of printing is permitted by the quota function.

As explained above, with the MFP 1 according to this embodiment, it is possible to perform different kinds of weighting processing respectively in the charging function and the quota function to calculate a charging value and a quota value and calculate a charging value and a quota value weighted according to respective purposes of charging and quota.

In this embodiment, the quota function is explained as a subtraction system for subtracting, from a quota value, a subtraction value of the image formation processing to be executed. However, the present invention is not limited to this. For example, in the same manner as the calculation of a subtraction value explained above, it is also possible to calculate processing values corresponding to the image formation processing about to be executed and, when a total of the processing values reaches a quota value set in advance, regulate the use of the MFP 1 by the user.

In this embodiment, the charging unit 204 calculates a charging value. However, the present invention is not limited to this. The charging unit 204 may calculate a final charging amount, output the charging amount itself, and store the charging amount in the storage area.

The method of calculating a charging value and a subtraction value and the method of calculating a charging amount and a quota value shown in this embodiment are examples only. The present invention is not limited to these calculation methods explained as examples. Calculation methods can be set as appropriate such that appropriate charging processing and quota processing can be performed.

In this embodiment, the first weight-value acquiring unit 204a and the second weight-value acquiring unit 205a explained as extracting weight values corresponding to the processing conditions acquired by the processing-condition-designation-information acquiring unit 203 from the weighting table and acquiring the weight values. However, the present invention is not limited to this. The first weight-value acquiring unit 204a and the second weight-value acquiring unit 205a may acquire weight values of all the processing conditions, temporarily store the weight values in the memory 4 or the like, and extract necessary weight values from the memory 4 or the like and perform calculation processing in actually calculating a charging value and a subtraction value.

In this embodiment, the image formation processing about to be executed is explained as being stopped when the quota value is smaller than 0. However, the present invention is not limited to this. For example, it is also possible to perform the image formation processing for the image forming job and prohibit printing from the next image forming job or display a warning indicating that the quota value is smaller than 0. Processing performed when the quota value is smaller than 0 can be set as appropriate.

### Second Embodiment

A second embodiment is explained below. An MFP according to the second embodiment is the same as the MFP according to the first embodiment in, for example, processing for calculating a charging value and a quota value in image formation processing. However, when operation input for instructing the image formation processing is performed, the MFP according to the second embodiment performs, for example, display of a weight value corresponding to a designated processing condition, a subtraction value obtained when processing is executed under designated conditions, and a quota value after the image formation processing obtained by subtracting the subtraction value from a quota value at that point. Consequently, in operation input for execution of the image formation processing, it is possible to check which degree of a subtraction value the image formation processing about to be executed corresponds to and how large a quota value is after the processing. Components same as those in the first embodiment are denoted by the same reference numerals and signs and explanation of the components is omitted.

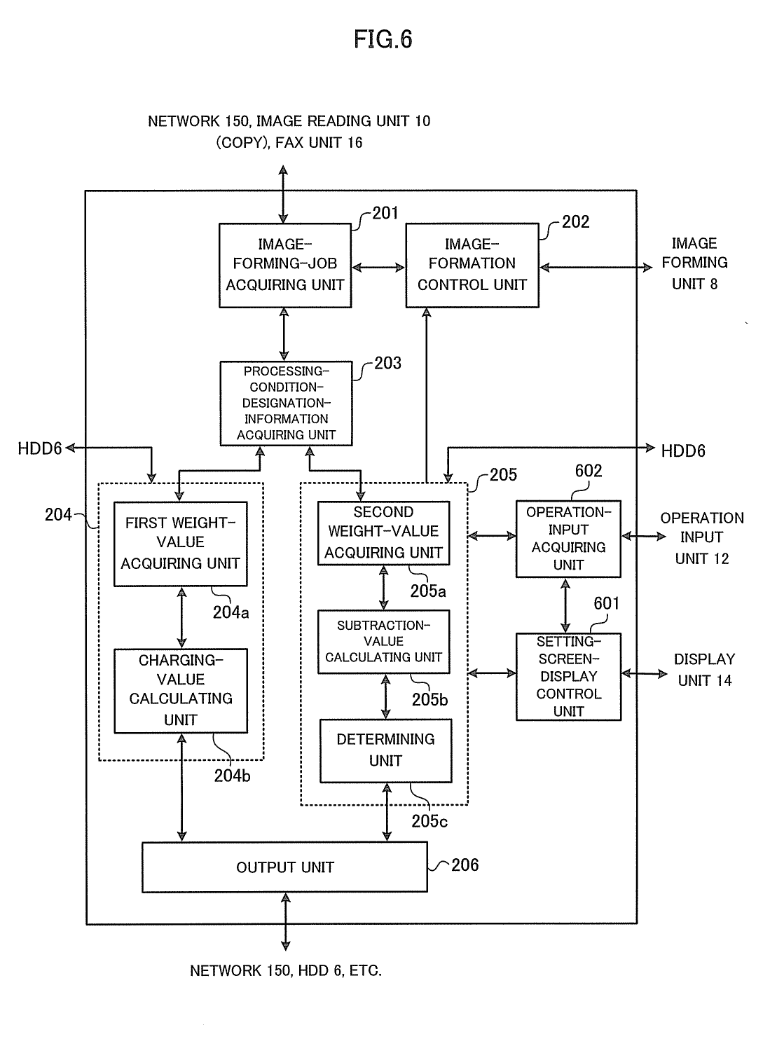

FIG. 6 is a functional block diagram for explaining functions of an MFP 1a according to this embodiment. The MFP 1a according to this embodiment further includes a setting-screen-display control unit 601 and an operation-input acquiring unit 602 in addition to the functional blocks of the MFP 1 according to the first embodiment.

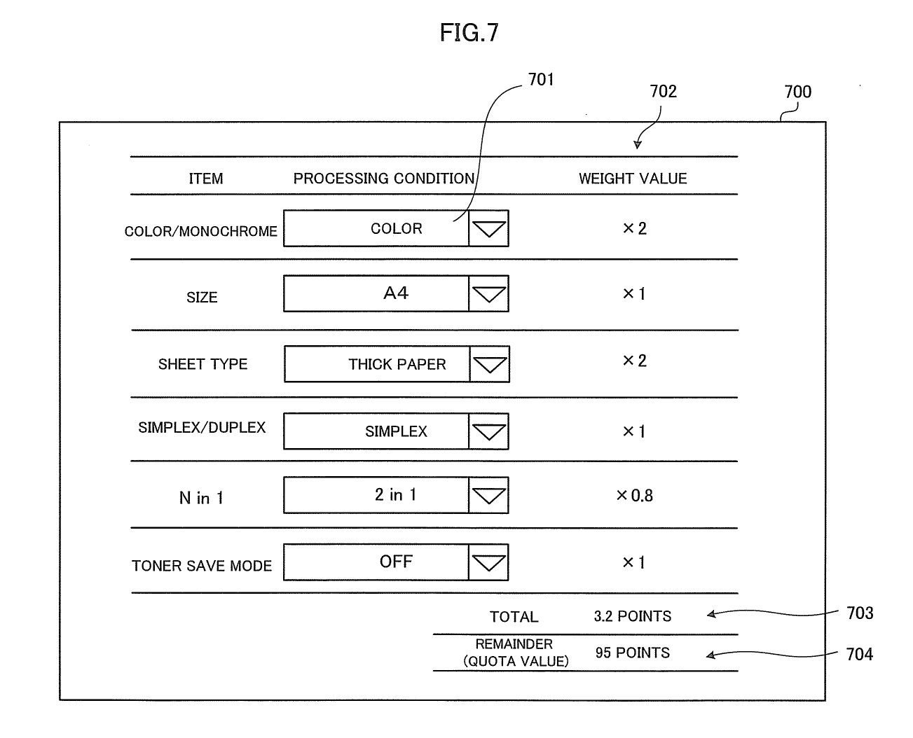

The setting-screen-display control unit 601 causes the display unit 14 of the MFP 1a to display a screen for setting processing conditions for image formation processing. An example of a setting screen 700 displayed by the setting-screen-display control unit 601 is shown in FIG. 7. For example, as shown in FIG. 7, the setting-screen-display control unit 601 causes the display unit 14 to display the setting screen 700 for designating conditions concerning items such as a sheet size, a type of a sheet, designation of duplex printing, designation of color or monochrome printing, and designation of layout printing (N in 1 printing).

The operation-input acquiring unit 602 acquires an operation input for the setting screen 700 displayed by the setting-screen-display control unit 601.

When processing conditions for the image formation processing are designated by an operation input from the operation input unit 12, the setting-screen-display control unit 601 performs processing for causing the display unit 14 to display a weight value corresponding to a designated processing condition, a subtraction value in the case of weighting with the weight value, a quota value after the image formation processing from which the subtraction value is subtracted, and the like. In FIG. 7, pull-down menu spaces 701 for designating conditions are displayed for respective items of the processing conditions. In a weight value display space 702 on the right side of the pull-down menu spaces 701, weight values corresponding to selected conditions are respectively displayed. A subtraction value calculated on the basis of the weight values corresponding to the processing conditions is displayed in a subtraction value display space 703. A quota value calculated by subtracting the subtraction value when printing is performed is displayed in a quota value display space 704.

The weight values, the subtraction value, and the quota value are respectively calculated by the second weight-value acquiring unit 205a, the subtraction-value calculating unit 205b, and the determining unit 205c of the quota unit 205 on the basis of an operation input from the operation input unit 12. The setting-screen-display control unit 601 displays the calculated respective values in the, display spaces corresponding thereto of the setting screen 700.

With the MFP 1a according to this embodiment explained above, it is possible to designate, before actually executing the image formation processing about to be executed, conditions for the image formation processing while checking a weight value corresponding to a designated processing condition, a subtraction value, a remaining quota value obtained when the image formation processing is actually executed under designated conditions, and the like. Therefore, if the remaining quota value is small, it is possible to, for example, change the conditions to condition setting for reducing the subtraction value. By designating conditions to reduce the subtraction value, it is also possible to perform condition setting for reducing consumption of toners and sheets as much as possible. This makes it easier to save consumables.

In this embodiment, the setting screen 700 is explained as being displayed on the display unit 14 of the MFP 1a. However, the present invention is not limited to this. For example, when printing is instructed from the terminal 160 connected via a network, the setting screen 700 may be displayed as a driver screen for setting conditions for the printing. When the setting screen 700 is displayed on a screen of the terminal 160, the functions of the second weight-value acquiring unit 205a, the subtraction-value calculating unit 205b, and the determining unit 205c of the quota unit 205, the setting-screen-display control unit 601, and the operation-input acquiring unit 602 only have to be realized in the terminal 160 by executing driver software installed in the terminal 160.

### Third Embodiment

A third embodiment is explained. An MFP according to this embodiment sets a quota separately for each of users and manages use of the MFP for each of the users. In order to set a quota for each of the users and calculate a quota value, when image formation processing is performed, identification processing for identifying which of the users performs the processing is performed. Specifically, before the image formation processing is performed, identification information for identifying a user is acquired and processing for subtracting a subtraction value corresponding to the image formation processing to be executed from a quota value corresponding to the identification information is performed. In the following explanation, components same as those in the first and second embodiments are denoted by the same reference numerals and signs and explanation of the components is omitted.

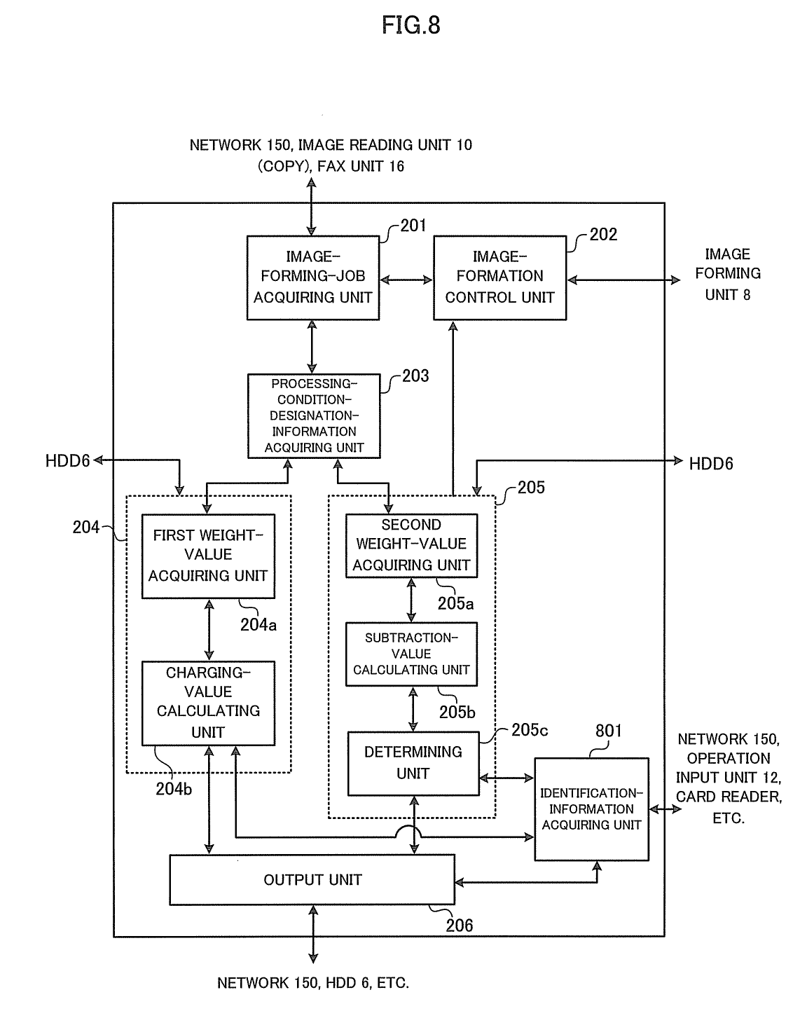

FIG. 8 is a functional block diagram for explaining functions of an MFP 1b according to this embodiment. The MFP 1b according to this embodiment includes, in addition to the functional blocks of the MFP 1 according to the first embodiment, an identification-information acquiring unit 801 configured to acquire identification information for identifying a user who instructs image formation processing about to be executed in the MFP 1b.

For example, when print instruction is performed in the terminal 160, the identification-information acquiring unit 801 can display a screen for inputting identification information on the screen of the terminal 160, acquire the input identification information, display the same screen on the display unit 14 of the MFP 1b, and acquire identification information input in the operation input unit 12. For example, the MFP 1b may include a card reader for reading a card having identification information stored therein. The identification-information acquiring unit 801 may acquire the identification information read by the card reader. A method of acquiring identification information is not specifically limited to these methods and may be any method as long as identification information for identifying a user can be acquired.

In the image formation processing, when a quota value is calculated for each of users, first, the quota unit 205 acquires identification information of a user who instructs an image forming job from the identification-information acquiring unit 801. The determining unit 205c acquires quota value stored in a predetermined storage area such as the HDD 6 and corresponding to the acquired identification information, subtracts a subtraction value calculated by the subtraction-value calculating unit 205b from the quota value, and calculates a quota value after execution of the image formation processing.

The output unit 206 overwrites the quota value corresponding to the acquired identification information with the new quota value after the subtraction and stores the new quota value.

With the MFP 1b according to this embodiment, it is possible to allocate a quota value to each of users who use the MFP 1b and limit printing in the MFP 1b to a predetermined printing amount for each of the users.

In order to appropriately manage a printing amount in the MFP 1b according to quota values allocated to the users, the MFP 1b may perform processing to prohibit the image formation processing of the MFP 1b unless authentication processing is performed according to identification information.

### Fourth Embodiment

A fourth embodiment is explained below. An MFP according to this embodiment changes, when a weight value for charging used in calculating a charging value is changed, a weight value for quota in association with the change of the weight value for charging. In the following explanation, components same as those in the embodiments explained above are denoted by the same reference numerals and explanation of the components is omitted.

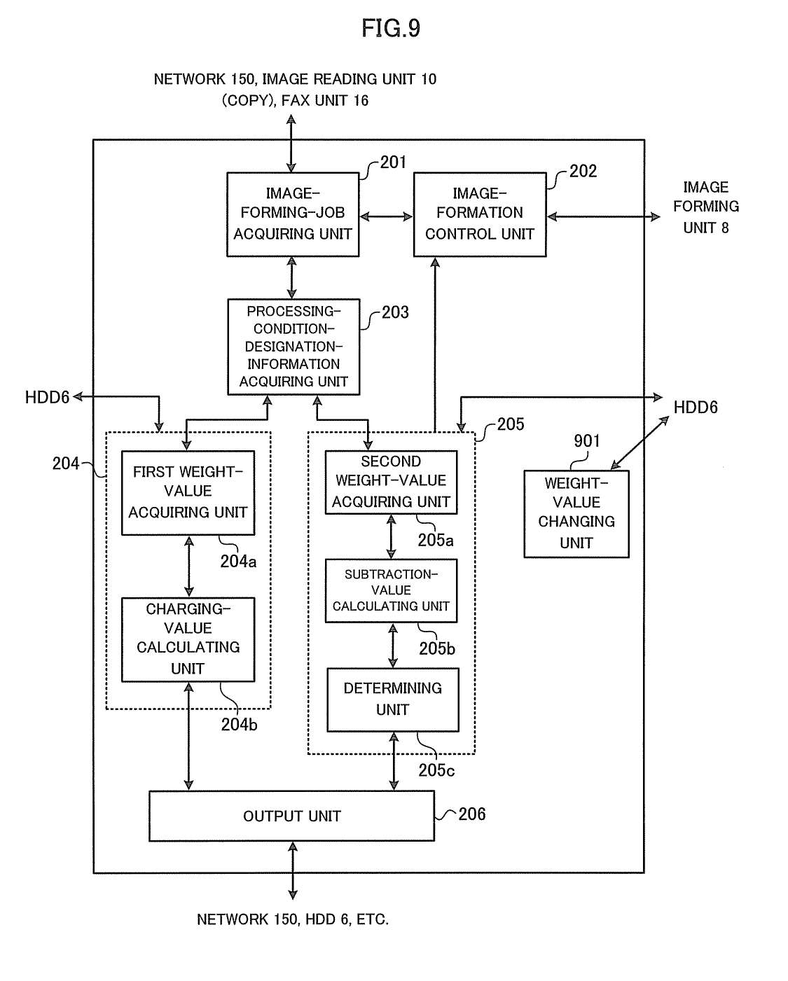

FIG. 9 is a functional block diagram for explaining functions of an MFP 1c according to this embodiment. The MFP 1c according to this embodiment is different from the first embodiment in that the MFP 1c further includes a weight-value changing unit 901 in addition to the functional blocks in the first embodiment.

The weight-value changing unit 901 checks, referring to the weighting table for charging 300, in which weight values for charging are registered in association with processing conditions, stored in the HDD 6, whether there is a change in the weight values for charging. For example, when there is a change in anyone of the weight values for charging compared with that referred to last time, the weight-value changing unit 901 performs processing for changing a weight value for quota for the same processing condition registered in the weighting table for quota 400 stored in the HDD 6.

For example, when a weight value for charging in selection of color printing is changed from 2 to 2.5 according to a rise in a price of color toners, the weight-value changing unit 901 accesses the weighting table for quota 400 and performs changing processing for increasing a weight value of the color printing. Consequently, it is possible to urge a user to select monochrome printing rather than the color printing with a high charging amount. Therefore, it is possible to suppress expenses of consumables.

The processing by the weight-value changing unit 901 for changing, referring to the weighting table for charging 300, a weight value for quota according to fluctuation in a weight value for charging may be executed at any timing. For example, when the image-forming-job acquiring unit 201 acquires an image forming job, the processing may be performed when the image forming job is executed or may be periodically performed at timing set in advance.

A degree for changing the weight value for quota according to the fluctuation in the weight value for charging can be set as appropriate by the weight-value changing unit 901. The degree may be set to a fluctuation ratio same as that of the weight value for charging or may be set larger than the fluctuation in the weight value for charging in order to more effectively limit use of the MFP 1c.

With the MFP is according to this embodiment explained above, the weight value for quota can be changed according to the fluctuation in the weight value for charging. Therefore, it is possible to perform management of use of the MFP 1c by a more appropriate quota function.

### Fifth Embodiment

A fifth embodiment is explained below. An MFP 1d according to this embodiment changes a weight value for quota according to residual amounts of consumables used in the MFP 1d. Therefore, the MFP 1d is different from the MFP 1c according to the fourth embodiment in a value set as a reference for changing a weight value for quota. In the following explanation, components same as those in the embodiments explained above are denoted by the same reference numerals and signs and explanation of the components is omitted.

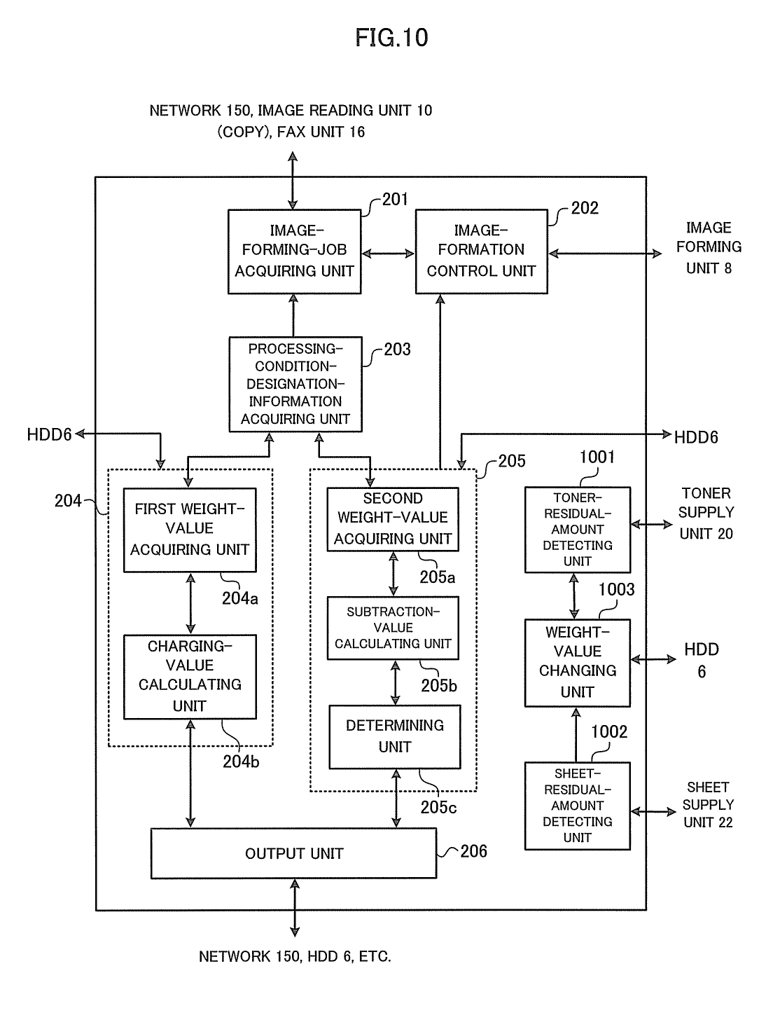

FIG. 10 is a functional block diagram for explaining functions of the MFP 1d according to this embodiment. The MFP 1d according to this embodiment is different from the first embodiment in that the MFP 1d further includes, in addition to the functional blocks in the first embodiment, a toner-residual-amount detecting unit 1001 configured to detect a residual amount of a toner as a consumable, a sheet-residual-amount detecting unit 1002 configured to detect a residual amount of sheets, and a weight-value changing unit 1003 configured to change a weight value for quota on the basis of information concerning the residual amounts of the consumables acquired from the detecting units.

The toner-residual-amount detecting unit 1001 acquires toner residual amount information indicating a toner residual amount from a toner supply unit 20 of the MFP 1d.

The sheet-residual-amount detecting unit 1002 acquires sheet residual amount information indicating a sheet residual amount from a sheet supply unit 22 of the MFP 1d.

The weight-value changing unit 1003 acquires the toner residual amount from the toner-residual-amount detecting unit 1001 and acquires the residual amount of sheets from the sheet-residual-amount detecting unit 1002. When the acquired toner residual amount and sheet residual amount are smaller than predetermined amounts, the weight-value changing unit 1003 changes weight values for quota related to the toner residual amount and the sheet residual amount.

Specifically, the toner-residual-amount detecting unit 1001 monitors the toner residual amount according to detection by a toner residual amount sensor or the like of the toner supply unit 20. When the toner is reduced by print processing and the toner-residual-amount detecting unit 1001 detects that the toner residual amount is smaller than the predetermined amount set in advance, the weight-value changing unit 1003 changes weight values for quote corresponding to processing conditions related to a consumed amount of the toner. For example, when there is a toner saving mode for forming an image with a small toner consumption amount, the weight-value changing unit 1003 can change the weight value to be smaller when the toner saving mode is selected and, conversely, change the weight value to be larger when the toner saving mode is off.

When the sheet-residual-amount detecting unit 1002 detects, according to detection by a sheet residual amount sensor or the like of the sheet supply unit 22, that the sheet residual amount is smaller than the predetermined amount set in advance, the weight-value changing unit 1003 changes weight value for quota corresponding to processing conditions related to a consumed amount of sheets. For example, it is possible to further reduce weight values corresponding to conditions of the layout printing (the N in 1 printing) for printing plural pages on one sheet, in which an image can be formed with a small sheet consumption amount, and urge a user to save sheets by designating the layout printing.

With the MFP 1d according to this embodiment, when a residual amount of a consumable such as a toner is small and it is desired to suppress consumption of the consumable, it is possible to effectively suppress use of the consumable.

In this embodiment, the weight values are explained as being changed on the basis of the toner residual amount and the sheet residual amount. However, the present invention is not limited to this. The weight values may be changed on the basis of residual amounts of consumables of the MFP other than the toner residual amount and the sheet residual amount. The weight values may be changed on the basis of one of the toner residual amount and the sheet residual amount.

The detection of the toner residual amount and the like and the processing for changing the weight value for quota based on fluctuation in the toner residual amount may be performed at any timing.

### Sixth Embodiment

A sixth embodiment of the present invention is explained below. An MFP 1e according to this embodiment changes a weight value for quota according to an amount of use of a member used in executing image formation processing in the MFP 1e.

An amount of use is, for example, the number of times of use, a frequency of use, or the like of the member. Members included in the MFP 1e do not decrease in the same manner as the consumable such as the toner set as the reference of fluctuation the weight value in the fifth embodiment. However, secular change, aged deterioration, or fatigue occurs little by little because of use. Therefore, weight values for processing conditions for using a member with a high frequency of use are changed to be large on the basis of an amount of use of the member. This makes it possible to suppress the use of the member and prevent a failure and the like of the member. In the following explanation, components same as those in the embodiments explained above are denoted by the same reference numerals and signs and explanation of the components is omitted.

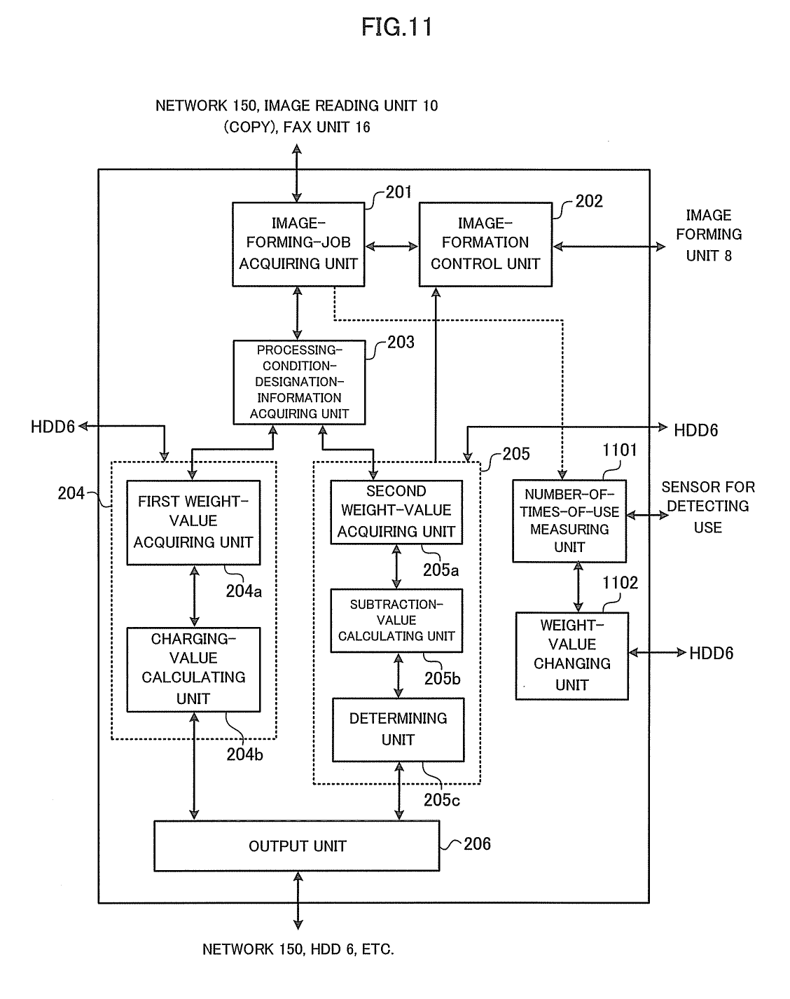

FIG. 11 is a functional block diagram for explaining functions of the MFP 1e according to this embodiment. The MFP 1e according to this embodiment further includes, in addition to the functional blocks in the first embodiment, a number-of-times-of-use measuring unit 1101 as a measuring unit configured to measure the numbers of times of use of the members of the MFP 1e and a weight-value changing unit 1102 configured to change weight values for quota on the basis of the numbers of times of use.

The number-of-times-of-use measuring unit 1101 counts, for respective members used by the MFP 1e in performing the image formation processing, the numbers of times of use as amounts of use of the members. The numbers of times of use can be measured by, for example, providing, in the respective members of the MFP 1e, sensors for detecting that the members are used and acquiring, from the sensors, signals indicating that the members are used. Instead of providing the sensors, members to be used may be registered in advance for each of processing conditions for printing designated in an image forming job. In this case, when the image forming job is acquired (an arrow of a broken line shown in FIG. 11), the number-of-times-of-use measuring unit 1101 can count the numbers of times of use by deducing, from processing conditions of the acquired image forming job, members used when the image formation processing is performed under to processing conditions.

The weight-value changing unit 1102 performs, on the basis of the numbers of times of use of the members counted by the number-of-times measuring unit 1101, processing for changing the weight values for quota registered in the weighting table for quota 400. Specifically, for example, the number of times of use for changing the weight values is set in advance and, when the number of times of use of a member reaches the number of times of use, the weight-value changing unit 1102 can change weight values of processing conditions for using the member to be larger. Consequently, since weight values of processing conditions for using a member having a high frequency of use can be increased, it is possible to urge a user to select processing in which the member is not used. Therefore, it is possible to suppress secular change and aged deterioration of the member having the high frequency of use.

### Seventh Embodiment

A seventh embodiment is explained below. An MFP 1f according to this embodiment changes weight values for quota according to an hour. When the number of image forming jobs acquired by the MFP 1f fluctuates depending on hours in one day, weight values in hours when there is a small number of image forming jobs (e.g., early in the morning or at night) among the hours in one day are set small and weight values in hours when there are a large number of image forming jobs (e.g., daytime) are set larger. This makes it possible to suppress use in hours when an image formation processing amount is large and a lot of users use the MFP 1f and urge a user to use the MFP 1f in hours when only a few users use the MFP 1f.

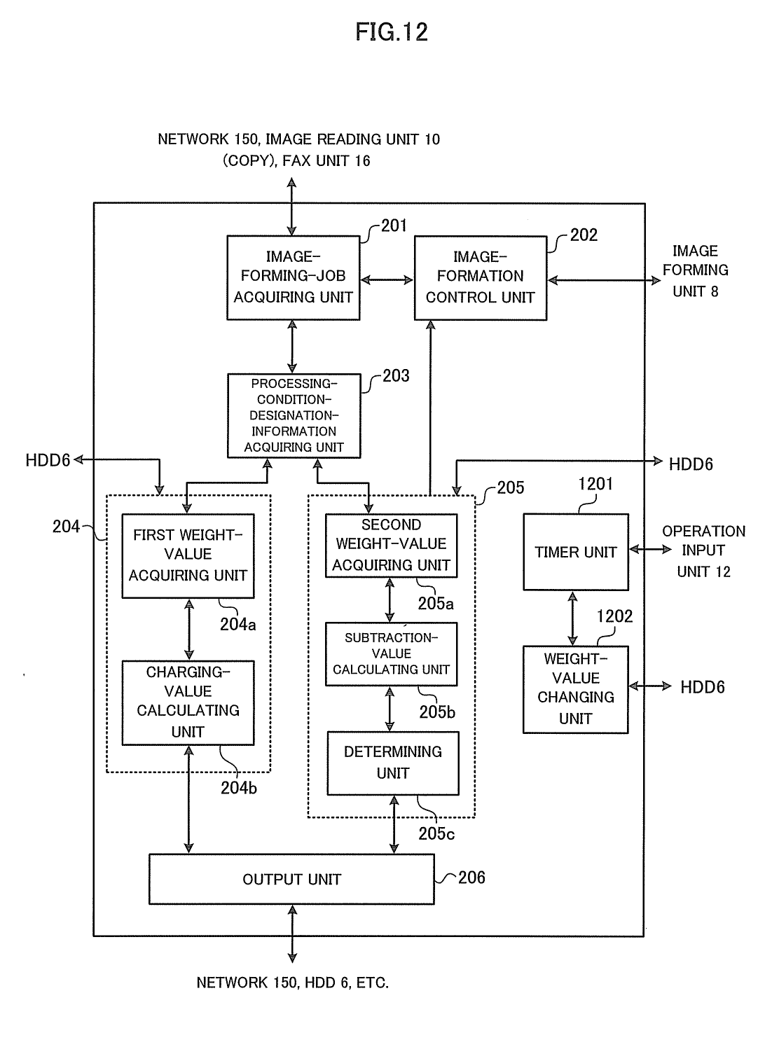

FIG. 12 is a functional block diagram for explaining functions of the MFP 1f according to this embodiment. The MFP 1f according to this embodiment further includes a timer unit 1201 and a weight-value changing unit 1202 in addition to the functional blocks in the first embodiment.

The timer unit 1201 instructs, at timing set in advance by an input of the operation input unit 12 or the like, the weight-value changing unit 1202 to change weight values. Timing for changing weight values may be designated as time or may be designated as a time interval such as “after certain hours”. A method of change of weight values by the timer unit 1201 may be any method. For example, the timer unit 1201 may output weight values themselves of processing conditions to be changed to the weight-value changing unit 1202 and instruct the weight-value changing unit 1202 to change weight values to the weight values. Plural weighting tables associated with changing timing may be registered in the weighting table for quota 400 in advance and the timer unit 1201 may output information for designating any one of the tables as an instruction.

The weight-value changing unit 1202 performs, on the basis of an instruction from the timer unit 1201, at designated timing, processing for changing weight values to weight values for quota corresponding to the timing. As explained above, the weight-value changing unit 1202 may receive output of weight values to be changed from the timer unit 1201 and change weight values to the output weight values. The weight-value changing unit 1202 may select a weighting table corresponding to changing timing from the plural weighting tables registered in advance and change weight values. Any method may be adopted as long as weight values can be changed at designated timing.

With the MFP if according to this embodiment, weight values can be changed at designated timing. Therefore, it is possible to suppress use of the MFP if at certain timing and urge a user to use the MFP if.

### Eighth Embodiment

An eighth embodiment is explained below. An MFP 1g according to this embodiment changes, among weight values for quota, weight values of processing conditions with larger weights to be larger and changes weight values of processing conditions with smaller weights to be smaller in order to suppress use of the MFP 1g when a quota value set in the MFP 1g or a quota value allocated to each of users who uses the MFP 1g is smaller than a predetermined value. Consequently, for example, when the remainder of a quota value for a user is small, the MFP 1g can urge the user to select processing conditions with smaller weights and perform image formation processing.

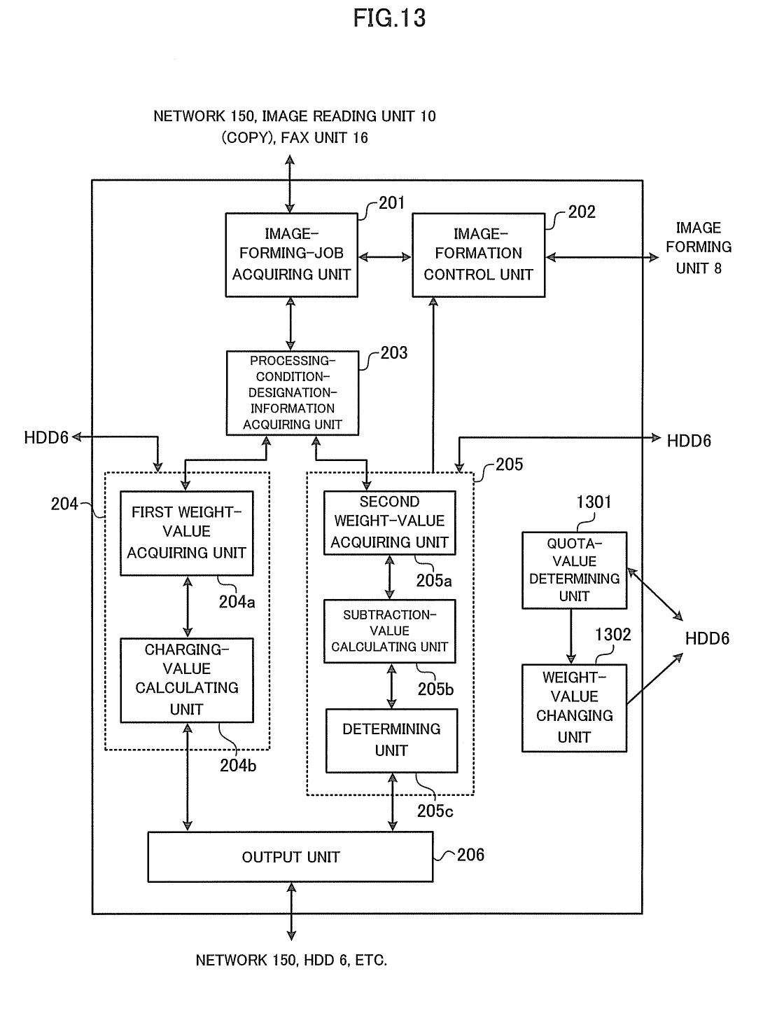

FIG. 13 is a functional block diagram for explaining functions of the MFP 1g according to this embodiment. The MFP 1g according to this embodiment further includes a quota-value determining unit 1301 as a second determining unit and a weight-value changing unit 1302 in addition to the functional blocks in the first embodiment.

The quota-value determining unit 1301 determines, referring to the quota values stored in the HDD 6, whether a quota value reaches the predetermined value set in advance. The quota-value determining unit 1301 performs processing for checking the quota value at predetermined timing. When the quota-value determining unit 1301 determines that the image formation processing is performed and the quota value decreases to be smaller than the predetermined value, the quota-value determining unit 1301 instructs the weight-value changing unit 1302 to change weight values.

When the weight-value changing unit 1302 receives, from the quota-value determining unit 1301, an instruction for changing weight values because the quota value is smaller than the predetermined value, the weight-value changing unit 1302 performs processing for changing the weight values. Specifically, as processing for changing the weight values, the weight-value changing unit 1302 changes, for example, among weight values corresponding to processing conditions, weight values of processing conditions with larger weights to be larger. The weight-value changing unit 1302 may perform processing for changing weight values of processing conditions with smaller weights to be smaller. The weight-value changing unit 1302 may execute both the changing processing for changing weight values to be larger and the changing processing for changing weight values to be smaller.

With the MFP 1g according to this embodiment, for example, when a quota value is smaller than the predetermined value and the remainder of the quota value is small, it is possible to urge a user to select processing conditions with small weight values and realize, for example, saving of consumables.

In the MFP 1g according to this embodiment, when a quota value is allocated to each of users as in the MFP 1b according to the third embodiment, the quota-value determining unit 1301 determines whether quota values of the users are smaller than the predetermined value. If there is a quota value smaller than the predetermined value, the quota-value determining unit 1301 can perform processing for changing weights of a user to whom the quota value is allocated.

As explained above in detail, according to the technique described in this specification, it is possible to provide an image forming apparatus that can perform optimum weighting matching purposes of charging and quota and perform appropriate charging processing and quota processing.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
a designation-information acquiring unit configured to acquire processing condition designation information for designating processing conditions for image formation processing;
a first weight-value acquiring unit configured to acquire a first weight value used for weighting in charging processing for the image formation processing, the first weight value corresponding to the processing condition designation information acquired by the designation-information acquiring unit;
a charging-value calculating unit configured to calculate, using the first weight value acquired by the first weight-value acquiring unit, a charging unit value used for calculation of a charging amount for the image formation processing;
a second weight-value acquiring unit configured to acquire, in limiting processing for limiting the image formation processing to a predetermined processing amount set in advance, a second weight value used for calculation of a subtraction value subtracted from the predetermined processing amount and corresponding to a processing amount of image formation processing to be executed, the second weight value corresponding to the processing condition designation information acquired by the designation-information acquiring unit;
a subtraction-value calculating unit configured to calculate the subtraction value on the basis of the second weight value acquired by the second weight-value acquiring unit; and
a first determining unit configured to determine whether a total of the subtraction value exceeds the predetermined processing amount.

2. The apparatus according to claim 1, further comprising an identification-information acquiring unit configured to acquire identification information for identifying a user who caused the apparatus to execute the image formation processing, wherein
the first determining unit determines whether a total of the subtraction value of the user corresponding to the identification information acquired by the identification-information acquiring unit exceeds the predetermined processing amount allocated in advance to the user corresponding to the identification information.

3. The apparatus according to claim 1, further comprising a weight-value changing unit configured to change, when the first weight value changes, the second weight value corresponding to the changing first weight value.

4. The apparatus according to claim 1, further comprising:
a residual-amount detecting unit configured to detect a residual amount of a consumable used for the image formation processing; and
a weight-value changing unit configured to change the second weight value on the basis of the residual amount of the consumable detected by the residual-amount detecting unit.

5. The apparatus according to claim 1, further comprising:
a measuring unit configured to measure an amount of use of a member used in the image formation processing; and
a weight-value changing unit configured to change the second weight value on the basis of the amount of use measured by the measuring unit.

6. The apparatus according to claim 1, further comprising:
a timer unit configured to output, at timing set in advance, an instruction for changing the second weight value; and
a weight-value changing unit configured to change the second weight value on the basis of an instruction from the timer unit.

7. The apparatus according to claim 1, wherein
the second weight value includes plural kinds of weight values respectively corresponding to plural processing conditions, and
the apparatus further comprises:
a second determining unit configured to determine whether the total of the subtraction value exceeds a predetermined threshold smaller than the predetermined processing amount set in advance; and
a weight-value changing unit configured to execute, when the second determining unit determines that the total of the subtraction value exceeds the predetermined threshold, among the plural kinds of weight values, at least one of processing for changing a weight value larger than predetermined weight to be larger and processing for changing a weight value smaller than the predetermined weight to be smaller.

8. A managing method comprising:
acquiring processing condition designation information for designating processing conditions for image formation processing;
acquiring a first weight value used for weighting in charging processing for the image formation processing, the first weight value corresponding to the acquired processing condition designation information;
calculating, using the acquired first weight value, a charging unit value used for calculation of a charging amount for the image formation processing;
acquiring, in limiting processing for limiting the image formation processing to a predetermined processing amount set in advance, a second weight value used for calculation of a subtraction value subtracted from the predetermined processing amount and corresponding to a processing amount of image formation processing to be executed, the second weight value corresponding to the acquired processing condition designation information;
calculating the subtraction value on the basis of the acquired second weight value; and
determining whether a total of the subtraction value exceeds the predetermined processing amount.

9. The method according to claim 8, further comprising:
acquiring identification information for identifying a user who caused an image forming apparatus to execute the image formation processing; and
determining whether a total of the subtraction value of the user corresponding to the acquired identification information exceeds the predetermined processing amount allocated in advance to the user corresponding to the identification information.

10. The method according to claim 8, further comprising changing, when the first weight value changes, the second weight value corresponding to the changing first weight value.

11. The method according to claim 8, further comprising:
detecting a residual amount of a consumable used for the image formation processing; and
changing the second weight value on the basis of the detected residual amount of the consumable.

12. The method according to claim 8, further comprising:
measuring an amount of use of a member used in the image formation processing; and
changing the second weight value on the basis of the measured amount of use.

13. The method according to claim 8, further comprising:
outputting, at timing set in advance, an instruction for changing the second weight value; and
changing the second weight value on the basis of an instruction for changing the second weight value.

14. The method according to claim 8, wherein
the second weight value includes plural kinds of weight values respectively corresponding to plural processing conditions, and
the method further comprises:
determining whether the total of the subtraction value exceeds a predetermined threshold smaller than the predetermined processing amount set in advance; and
executing, when it is determined that the total of the subtraction value exceeds the predetermined threshold, among the plural kinds of weight values, at least one of processing for changing a weight value larger than predetermined weight to be larger and processing for changing a weight value smaller than the predetermined weight to be smaller.

15. A computer-readable recording medium having recorded therein a computer program for causing a computer to execute processing for:
acquiring processing condition designation information for designating processing conditions for image formation processing;
acquiring a first weight value used for weighting in charging processing for the image formation processing, the first weight value corresponding to the acquired processing condition designation information;
calculating, using the acquired first weight value, a charging unit value used for calculation of a charging amount for the image formation processing;
acquiring, in limiting processing for limiting the image formation processing to a predetermined processing amount set in advance, a second weight value used for calculation of a subtraction value subtracted from the predetermined processing amount and corresponding to a processing amount of image formation processing to be executed, the second weight value corresponding to the acquired processing condition designation information;
calculating the subtraction value on the basis of the acquired second weight value; and
determining whether a total of the subtraction value exceeds the predetermined processing amount.

16. The recording medium according to claim 15, further causing the computer to execute processing for:
acquiring identification information for identifying a user who caused an image forming apparatus to execute the image formation processing; and
determining whether a total of the subtraction value of the user corresponding to the acquired identification information exceeds the predetermined processing amount allocated in advance to the user corresponding to the identification information.

17. The recording medium according to claim 15, further causing the computer to execute processing for changing, when the first weight value changes, the second weight value corresponding to the changing first weight value.

18. The recording medium according to claim 15, further causing the computer to execute processing for:
detecting a residual amount of a consumable used for the image formation processing; and
changing the second weight value on the basis of the detected residual amount of the consumable.

19. The recording medium according to claim 15, further causing the computer to execute processing for:
measuring an amount of use of a member used in the image formation processing; and
changing the second weight value on the basis of the measured amount of use.

20. The recording medium according to claim 15, further causing the computer to execute processing for:
outputting, at timing set in advance, an instruction for changing the second weight value; and
changing the second weight value on the basis of an instruction for changing the second weight value.
